(19) United States
(12) Patent Application Publication
(10) Pub. No.: US 2022/0379719 A1
(43) Pub. Date: Dec. 1, 2022

(54) COMPOSITE FUEL TANK AND SYSTEM AND METHOD FOR MAKING A COMPOSITE FUEL TANK

(71) Applicant: The Boeing Company, Chicago, IL (US)

(72) Inventors: Brian Hempe, Santa Monica, CA (US); Christopher P. Henry, Thousand Oaks, CA (US)

(73) Assignee: The Boeing Company, Chicago, IL (US)

(21) Appl. No.: 17/728,044

(22) Filed: Apr. 25, 2022

Related U.S. Application Data
(60) Provisional application No. 63/193,155, filed on May 26, 2021.

(51) Int. Cl. B60K 15/03; B29C 70/34; B29C 63/28

(52) U.S. Cl. CPC B60K 15/03177; B29C 70/342; B29C 63/28; B60K 2015/03046; B29L 2031/7172

(57) ABSTRACT

A composite fuel tank includes a tank-shell and a tank-liner, located within the tank-shell. The tank-shell is formed from a composite layup that is placed, consolidated, and cured on a bladder. The bladder forms the tank-liner after formation of the tank-shell.

### PRIORITY

This application claims from U.S. Ser. No. 63/193,155 filed on May 26, 2021.

### FIELD

The present disclosure relates generally to fuel storage tanks and, more particularly, to composite fuel tanks, including an outer tank shell and an interior tank liner, and systems and methods for making the same.

### BACKGROUND

Fuel storage tanks are designed to hold a liquid fuel. Some fuel storage tanks include a thin, non-structural liner wrapped with a structural fiber composite. The liner provides a barrier between the liquid fuel and the composite, preventing amongst others leaks and chemical degradation of the structural fiber composite. However, current composite fabrication techniques used to make lined composite fuel tanks are complex, time consuming, and/or expensive. Accordingly, those skilled in the art continue with research and development efforts in the field of fuel storage tanks made of composite materials that include an internal liner.

### SUMMARY

Disclosed are examples of a composite fuel tank, a system for making a composite fuel tank, and a method of making a composite fuel tank. The following is a non-exhaustive list of examples, which may or may not be claimed, of the subject matter according to the present disclosure.

In an example, the disclosed system includes a bladder, configured to be inflated to support a composite layup formed on at least a portion of the bladder, and a mold configured to receive the composite layup and the bladder. The bladder is further configured to be pressurized to compress the composite layup against the mold. The composite layup is cured within the mold 108 to form a tank-shell. The bladder 104 is configured to form a tank-liner within the tank-shell.

In an example, the disclosed method includes steps of: (1) inflating a bladder; (2) forming a composite layup on at least a portion of the bladder; (3) pressurizing the bladder to compress the composite layup against a mold; (4) curing the composite layup to form a tank-shell; and (5) forming a tank-liner within the tank-shell from the bladder.

In an example, the disclosed composite fuel tank includes a tank-shell, and a tank-liner located within the tank-shell. The tank-shell is formed from a composite layup that is placed, consolidated, and cured on a bladder. The bladder forms the tank-liner after formation of the tank-shell.

Other examples of the disclosed composite fuel tank, system, and method will become apparent from the following detailed description, the accompanying drawings, and the appended claims.

### BRIEF DESCRIPTION OF THE DRAWINGS

FIG. 1 is a schematic, plan view of a thermoplastic film used to make a bladder;

FIG. 2 is a schematic, perspective view of an example of the bladder;

FIG. 3 is a schematic, perspective view of an example of a composite layup formed on the bladder;

FIG. 4 is a schematic, perspective view of an example of a composite fuel tank;

FIG. 5 is a schematic, sectional view of an example of a portion of a system used to make the composite fuel tank;

FIG. 6 is a schematic, sectional view of an example of the composite fuel tank;

FIG. 7 is a schematic, perspective view of an example of the composite layup formed on the bladder;

FIG. 8 is a schematic, perspective view of an example of the composite fuel tank;

FIG. 9 is a schematic, perspective view of an example of the composite layup formed on the bladder;

FIG. 10 is a schematic, perspective view of an example of the composite fuel tank;

FIG. 11 is a schematic, perspective, exploded view of an example of the composite fuel tank;

FIG. 12 is a schematic, perspective view of the example of the composite fuel tank of FIG. 11;

FIG. 13 is a schematic, perspective view of an example of the bladder and a frame member;

FIG. 14 is a schematic, perspective view of an example of the composite fuel tank;

FIG. 15 is a schematic, sectional view of an example of the system;

FIG. 16 is a schematic, sectional view of an example of the composite fuel tank;

FIG. 17 is a schematic, sectional view of an example of the composite fuel tank;

FIG. 18 is a schematic, perspective view of an example of the bladder and a second bladder;

FIG. 19 is a schematic, perspective view of an example of the composite layup formed on the bladder and the second bladder;

FIG. 20 is a schematic, perspective view of an example of the composite fuel tank;

FIG. 21 is a schematic, sectional view of an example of a portion of the system;

FIG. 22 is a schematic, sectional view of an example of the composite fuel tank;

FIG. 23 is a schematic, sectional view of an example of a portion of the system;

FIG. 24 is a schematic, sectional view of an example of the composite fuel tank;

FIG. 25 is a flow diagram of an example of a method of making a composite fuel tank;

FIG. 26 is a flow diagram of an example of an aircraft manufacturing and service methodology;

FIG. 27 is a schematic block diagram of an example of an aircraft; and

FIG. 28 is a schematic illustration of an example of the aircraft.

### DETAILED DESCRIPTION

The present disclosure is related to composite fuel tanks that provide a fuel-tight bladder, or liner, located inside of a consolidated and cured composite, which would otherwise be too difficult and/or costly to replace. As used in the present disclosure, the terms “consolidate,” “consolidated,” “consolidating,” “consolidation,” and similar terms, in reference to a composite article, have their ordinary meaning as known in the art and refer to, but are not limited to, a phase in composite manufacturing during which pressure and, optionally, heat are applied to the composite article to squeeze air and resin out of the composite with the intention of obtaining a monolithic structure from discrete plies. As used in the present disclosure, the terms “cure,” “cured,” “curing,” and similar terms, in reference to a composite article, have their ordinary meaning as known in the art and refer to, but are not limited to, a phase in composite manufacturing during which heat and, optionally, pressure are applied to the composite article to anneal, dry, toughen, and/or harden the composite.

The present disclosure is also related to systems and methods that facilitate in-situ application of the fuel-tight bladder/liner within the composite shell during fabrication of the composite fuel tank. The thinness, low cost, and simplicity of the bladder/liner reduces the technical and economic barriers to introduction and use of attritable or disposable (e.g., single use or reusable, but eventually expendable) fuel tanks. Furthermore, the systems and methods disclosed herein facilitate significant reductions in design and fabrication time by enabling unitized composite designs that would otherwise preclude integration of the bladder/liner.

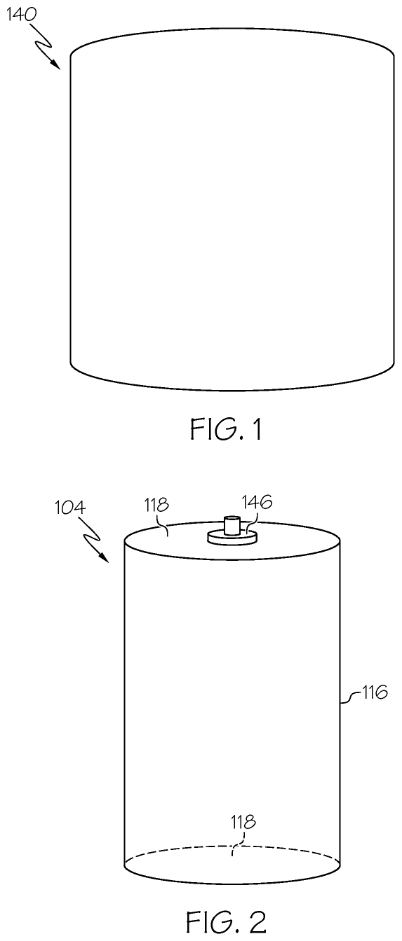

Referring to FIGS. 1-24, by way of examples, the present disclosure is directed to a composite fuel tank 102. In one or more examples, the composite fuel tank 102 includes a tank-shell 112 and a tank-liner 114. The tank-liner 114 is located within the tank-shell 112. The tank-shell 112 is formed from a composite layup 106, which is placed, consolidated, and cured on a bladder 104. The bladder 104 forms the tank-liner 114 after formation of the tank-shell 112.

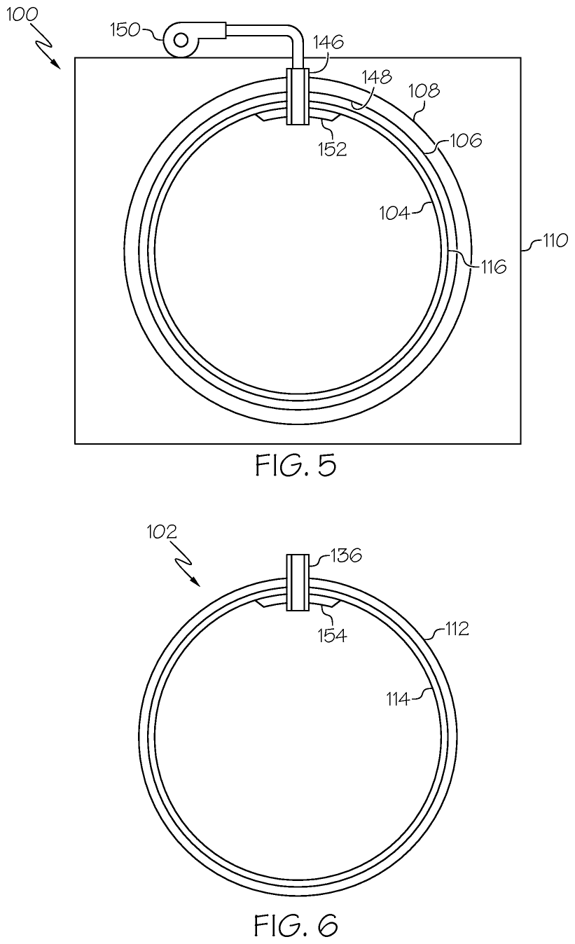

Referring to FIGS. 1-24, by way of examples, the present disclosure is directed to a system 100 for making the composite fuel tank 102. In one or more examples, the system 100 includes the bladder 104 and a mold 108 (e.g., as shown in FIGS. 5, 15, 21 and 23). The bladder 104 is configured to be inflated to support the composite layup 106, which is formed on at least a portion of the bladder 104. The mold 108 is configured to receive the composite layup 106 and the bladder 104. The bladder 104 is further configured to be pressurized to compress the composite layup 106 against the mold 108. The composite layup 106 is cured within the mold 108 to form the tank-shell 112. The bladder 104 remains in place and is configured to form the tank-liner 114 within the tank-shell 112, after formation (e.g., consolidation and cure) of the tank-shell 112.

Accordingly, the bladder 104 is a dual-purpose component. During fabrication of the tank-shell 112, the bladder 104 serves as an inflatable fabrication mandrel (e.g., an air-tight polymeric bag) for laying up, consolidating, and curing the composite layup 106 (e.g., reinforcement consolidation of thermosetting composites). The bladder 104 remains in place during consolidation and cure of the composite layup 106. As such, after formation of the tank-shell 112, the bladder 104 serves as, or forms, the tank-liner 114 (e.g., a fuel-tight bladder/liner) of the composite fuel tank 102.

Generally, the bladder 104 has sufficient thermomechanical properties (e.g., heat stability, elongation capability, pin hole resistance, etc.) to substantially aide the consolidation and cure process, yet also has sufficient properties (e.g., low fuel permeability, electrical conductivity, etc.) to serve as the tank-liner 114 and contain liquid fuel. In one or more examples, the bladder 104 and, thus, the tank-liner 114 is heat stable. In one or more examples, the bladder 104 and, thus, the tank-liner 114 is stretchable. In one or more examples, the bladder 104 and, thus, the tank-liner 114 is pinhole resistant.

In one or more examples, the bladder 104 and, thus, the tank-liner 114 is made of a thermoplastic material. In one or more examples, the bladder 104 and, thus, the tank-liner 114 is made of a thermoplastic film (e.g., thermoplastic film 140 shown in FIG. 1). In one or more examples, the bladder 104 and, thus, the tank-liner 114 is made of a single ply of thermoplastic film. In one or more examples, the bladder 104 and, thus, the tank-liner 114 is made of a plurality of plies of thermoplastic film.

In one or more examples, a composition of the thermoplastic material includes additives for fuel resistance. In one or more examples, the composition of the thermoplastic material includes additives for electrical conductivity to mitigate static electricity and light strike.

In one or more examples, the bladder 104 and, thus, the tank-liner 114 is made of a polymeric material. In one or more examples, the bladder 104 and, thus, the tank-liner 114 is made of polymeric bagging, such as that used to aide thermosetting composite consolidation during cure (e.g., vacuum bagging).

In one or more examples, the bladder 104 and, thus, the tank-liner 114 includes, or is made of, a polyamide. In one or more examples, the bladder 104 and, thus, the tank-liner 114 includes a polymer composition that includes polyimide component, an impact modifier, and a binding filler. In one or more examples, the polyamide component includes a polyamide selected from the group of polyamide 6, polyamide 6/6, polyamide 6/66, and combinations thereof. In one or more examples, the polyamide component includes polyamide oligomers. In one or more examples, the polyamide oligomers are present in an amount up to 5 parts by weight of per 100 parts by weight of the polyamide component. In one or more examples, the impact modifier includes an organic copolymer. In one or more examples, the impact modifier is present in an amount of up to 30 parts by weight per 100 parts by weight of the polymer composition. In one or more examples, the binding filler is not covalently bonded to the polyamide. In one or more examples, the binding filler includes at least one of silica and cyclodextrin. In one or more examples, the binding filler is present in an amount of up to 10 parts by weight per 100 parts by weight of the polymer composition.

In one or more examples, the bladder 104 and, thus, the tank-liner 114 is resistant to permeation, absorption, seepage, and/or leakage of liquid fuel, such as gasoline, kerosene, jet fuel (e.g., Jet Propellant 8), and the like. In one or more examples, the bladder 104 and, thus, the tank-liner 114 is resistant to permeation, absorption, seepage, and/or leakage of liquid fuel for a minimum time, such as for at least 12 hours. For example, during use of the composite fuel tank 102, the tank-liner 114 maintains a minimal liquid fuel absorption (e.g., a weight increase of less than approximately 25 percent) due to seepage of the liquid fuel for at least the minimum time (e.g., 12 hours).

Resistance to permeation, seepage, and leakage of liquid fuel for the minimum time (e.g., at least 12 hours) can be achieved in one or more ways. In one or more examples, a material composition of the bladder 104 and, thus, the tank-liner 114 (e.g., of the thermoplastic material) is selected to stay below the seepage threshold for the minimum time. In one or more examples, a thickness of the bladder 104 and, thus, the tank-liner 114 (e.g., of the single ply of thermoplastic film) is selected to stay below the seepage threshold for the minimum time. In one or more examples, the number of plies of thermoplastic film forming the bladder 104 and, thus, the tank-liner 114 is selected to stay below the seepage threshold for the minimum time.

Referring to FIGS. 1 and 2, the bladder 104 (e.g., as shown in FIG. 2) is an air-tight bag that forms an enclosed internal volume. In one or more examples, the bladder 104 is formed from a sheet of thermoplastic material, such as a sheet of the thermoplastic film 140 (e.g., as shown in FIG. 1). The thermoplastic film 140 is suitably cut, shaped, and connected to form a desired three-dimensional shape of the bladder 104. Portions of the thermoplastic film 140 can be connected to other portions of the thermoplastic film 140 to form the bladder 104 via any one of various material connecting techniques, such as, but not limited to, adhesive bonding, ultrasonic welding, heat sealing, plastic welding, and the like.

In one or more examples, the bladder 104 is tubular with an opposed pair of closed ends, which form the enclosed internal volume. In one or more examples, the bladder 104 is approximately cylindrical. However, in other examples, the bladder 104 can have any one of various other three-dimensional shapes, such as, but not limited to, cubical, pyramidal, conical, and the like or may have a more complex geometry.

As illustrated in FIG. 2, in one or more examples, the bladder 104 includes a peripheral bladder-surface 116 and an opposed pair of end bladder-surfaces 118. In examples in which the bladder 104 is cylindrical, the peripheral bladder-surface 116 may be referred to as circumferential bladder-surface. The peripheral bladder-surface 116 has a closed cross-sectional shape. Each one of the end bladder-surfaces 118 extends from and encloses a respective end of the peripheral bladder-surface 116.

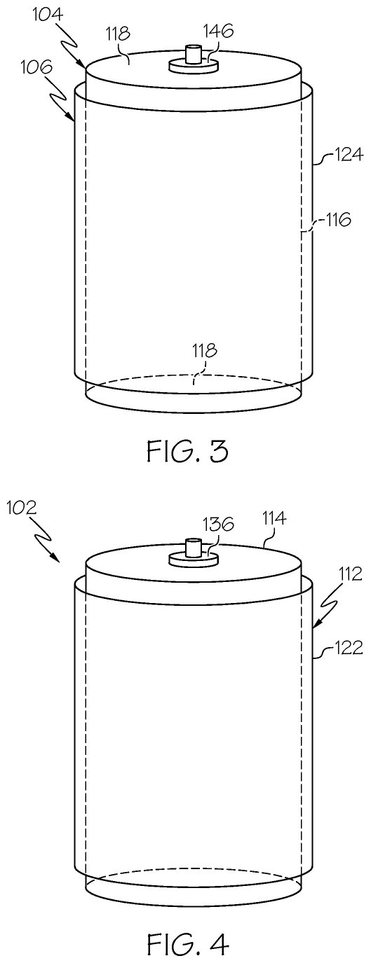

Referring now to FIG. 3, in one or more examples, the composite layup 106 includes at least one ply of composite material (e.g., a composite ply 124) placed on (e.g., around) the peripheral bladder-surface 116 of the bladder 104. The composite layup 106 can include any number (e.g., one or more) of composite plies. The composite material includes a reinforcement material embedded in a polymeric matrix material. In one or more examples, the composite material is pre-impregnated (“pre-preg”) thermoset composite material.

The composite layup 106 can be placed on (e.g., around) the peripheral bladder-surface 116 of the bladder 104 via any one of various composite layup techniques. As an example, one or more sheets of composite material can be laid up on the peripheral bladder-surface 116, either manually or by a composite placement machine, to form the composite layup 106. As another example, tows or strips of composite tape can be laid up on the peripheral bladder-surface 116, for example, using an automated fiber placement (AFP) machine or an automated tape laying (ATL) machine.

As illustrated in FIG. 3, in one or more examples, the composite layup 106 is formed around substantially an entirety of the peripheral bladder-surface 116, for example, from proximate (e.g., at or near) one (e.g., a first) end of the peripheral bladder-surface 116 to proximate an opposing (e.g., second) end of the peripheral bladder-surface 116. In these examples, the composite layup 106 takes the tubular shape of the peripheral bladder-surface 116 of the bladder 104 and has a closed cross-sectional shape with two open ends.

During placement of the composite layup 106, the bladder 104 is inflated, or initially pressurized, into the suitable three-dimensional shape to form a layup mandrel capable of supporting the composite layup 106. In one or more examples, the bladder 104 includes an air fitting 146. The air fitting 146 is coupled to the bladder 104 (e.g., the thermoplastic film 140), extends through the bladder 104, and/or is in fluid communication with the internal volume of the bladder 104. The air fitting 146 is configured to enable air, or another gas or liquid, to be introduced within the bladder 104 to pressurize and inflate the bladder 104.

In one or more examples, the air fitting 146 is located on one of the end bladder-surfaces 118. In one or more examples, the air fitting 146 is located on the peripheral bladder-surface 116. In one or more examples, the bladder 104 includes more than one air fitting 146 located on one or both of the end bladder-surfaces 118 and/or the peripheral bladder-surface 116.

Referring now to FIG. 4, in one or more examples, the composite layup 106, placed on the peripheral bladder-surface 116, is consolidated and cured on the bladder 104 (e.g., as shown in FIG. 3) to form the tank-shell 112. In one or more examples, the tank-shell 112 includes a peripheral tank-wall 122. In these examples, peripheral tank-wall 122 takes the tubular shape of the peripheral bladder-surface 116 of the bladder 104 and has a closed cross-sectional shape with two open ends. The bladder 104 remains within the tank-shell 112 and forms the tank-liner 114.

Referring now to FIG. 5, in one or more examples, the system 100 includes a pump 150. The pump 150 includes any suitable mechanism or device configured to move air, or another gas or liquid, into the internal volume of the bladder 104. The pump 150 is used to inflate (e.g., initially pressurize) the bladder 104 for placement of the composite layup 106 on the peripheral bladder-surface 116 of the bladder 104.

In one or more examples, the mold 108 is configured to receive the composite layup 106 and the bladder 104. In one or more examples, the mold 108 includes a mold surface 148 that forms a mold cavity and that is configured to shape an exterior of the composite layup 106 and, thus, the tank-shell 112 (e.g., as shown in FIG. 6). Generally, the mold surface 148 of the mold 108 has a shape that is complementary to the shape of the bladder 104. For example, the mold surface 148 includes a surface-portion that corresponds to the peripheral bladder-surface 116 and surface-portions that correspond to each one of the end bladder-surfaces 118 (e.g., as shown in FIGS. 2 and 3).

After the composite layup 106 is formed on the peripheral bladder-surface 116 of the bladder 104, the composite layup 106 and the bladder 104 are placed within the mold 108. The bladder 104 remains inflated (e.g., initially pressurized) while the composite layup 106 and the bladder 104 are placed within the mold 108.

In one or more examples, the mold 108 is configured to enable bladder 104 to remain coupled to or to be reconnected to (e.g., in fluid communication with) the pump 150. As an example, the mold 108 is configured to enable the pump 150 to access and be coupled to the air fitting 146. As another example, the mold 108 is configured to enable the air fitting 146 to extend through the mold 108. As another example, the mold 108 includes another air fitting (not shown) that is configured to be coupled to the air fitting 146 of the bladder 104 and to the pump 150.

With the composite layup 106 and the bladder 104 positioned within the mold 108, the bladder 104 is further inflated (e.g., further pressurized), for example, via the pump 150, to compress the composite layup 106 against the mold surface 148 of the mold 108 and consolidate the composite layup 106. During further pressurization of the bladder 104 and consolidation of the composite layup 106, the peripheral bladder-surface 116 is configured to shape an interior surface of the composite layup 106 and, thus, an interior surface (e.g., an inner mold line) of the peripheral tank-wall 122 of the tank-shell 112, and the mold surface 148 is configured to shape an exterior surface of the composite layup 106 and, thus, an exterior surface (e.g., an outer mold line) of the peripheral tank-wall 122 of the tank-shell 112.

Referring still to FIG. 5, in one or more examples, the system 100 includes a curing apparatus 110. In one or more example, curing apparatus 110 is configured to receive the mold 108, the composite layup 106, and the bladder 104. The curing apparatus 110 is configured to cure the composite layup 106, positioned on the bladder 104 and within the mold 108, while the bladder 104 is pressurized to consolidate the composite layup 106 against the mold 108. In one or more examples, the curing apparatus 110 is configured to apply heat to the composite layup 106 during consolidation and/or cure. In one or more examples, the curing apparatus 110 is configured to apply pressure to the composite layup 106 during consolidation and/or cure. In one or more examples, the curing apparatus 110 is an oven. In one or more examples, the curing apparatus 110 is an autoclave. In one or more examples, the curing apparatus 110 is a heat blanket configured to be applied (e.g., wrapped around) the mold 108. Other curing techniques are also contemplated, such as, but not limited to, photocuring, ultraviolet (UV) light curing, and other suitable curing processes.

Referring now to FIG. 6, which illustrates an example of the composite fuel tank 102 after consolidation and cure of the composite layup 106 (e.g., as shown in FIG. 5). After formation of the composite fuel tank 102, the bladder 104 is depressurized. Thereafter, the bladder 104 forms the tank-liner 114 of the composite fuel tank 102. In one or more examples, the composite fuel tank 102 includes a fuel fitting 136. The fuel fitting 136 is configured to enable liquid fuel to be introduced within the composite fuel tank 102 (e.g., interior to the tank-liner 114).

In one or more examples, the fuel fitting 136 is coupled to the tank-liner 114, extends through the tank-liner 114, and/or is in fluid communication with an interior volume of the composite fuel tank 102 (e.g., interior to the tank-liner 114). In one or more examples, the fuel fitting 136 is coupled to the tank-shell 112, extends through the tank-shell 112 and the tank-liner 114, and is in fluid communication with the internal volume of the composite fuel tank 102 (e.g., interior to the tank-liner 114).

In one or more examples, the air fitting 146 (e.g., as shown in FIG. 5) is repurposed as the fuel fitting 136 (e.g., the air fitting 146 and the fuel fitting 136 are the same fitting). In one or more examples, the air fitting 146 is replaced by the fuel fitting 136. In these examples, the fuel fitting 136 uses the same openings in the tank-shell 112 and the tank-liner 114 that were previously occupied by the air fitting 146. In one or more examples, the fuel fitting 136 is an additional fitting that is coupled to the tank-shell 112 and that extends through the tank-shell 112 and the tank-liner 114. In these examples, the air fitting 146 is capped or removed and the openings in the tank-shell 112 and the tank-liner 114 that were previously occupied by the air fitting 146 are sealed.

Referring again to FIG. 5, in one or more examples, the air fitting 146 includes at least one interface plate 152. The interface plate 152 is configured to form an air-tight seal between the air fitting 146 and the bladder 104. In one or more examples, the interface plate 152 is positioned on an interior surface of the bladder 104 (e.g., is an interior interface plate).

Referring again to FIG. 6, in one or more examples, the fuel fitting 136 includes at least one interface plate 154. The interface plate 154 is configured to form a liquid-tight seal between the fuel fitting 136 and tank-liner 114. In one or more examples, the interface plate 154 is positioned on an interior surface of the tank-liner 114 (e.g., is an interior interface plate).

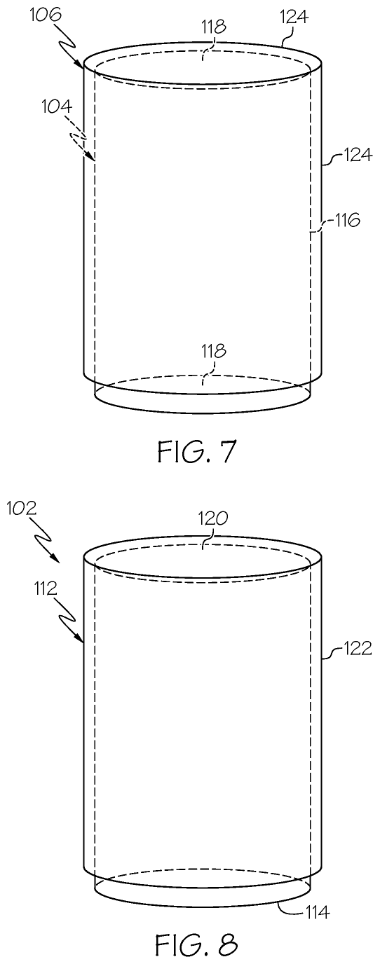

Referring now to FIG. 7, in one or more examples, the composite layup 106 also includes at least one composite ply 124, which is placed on (e.g., over) at least one of the pair of end bladder-surfaces 118 of the bladder 104. In these examples, the composite layup 106 takes the tubular shape of the peripheral bladder-surface 116 of the bladder 104 and has a closed cross-sectional shape with one closed end and one open end. In FIG. 7, the air fitting 146 is not shown for the purpose of simplicity of illustration.

Referring now to FIG. 8, in one or more examples, the composite layup 106 (e.g., as shown in FIG. 7), placed on the peripheral bladder-surface 116 and one of the end bladder-surfaces 118, is consolidated and cured on the bladder 104, as described herein above, to form the tank-shell 112. In one or more examples, the tank-shell 112 includes the peripheral tank-wall 122 and an end tank-wall 120 that is coupled to the peripheral tank-wall 122. In these examples, peripheral tank-wall 122 takes the tubular shape of the peripheral bladder-surface 116 of the bladder 104 and has a closed cross-sectional shape with an open end and a closed end formed by the end tank-wall 120. The bladder 104 remains within the tank-shell 112 and forms the tank-liner 114. In FIG. 8, the fuel fitting 136 is not shown for the purpose of simplicity of illustration.

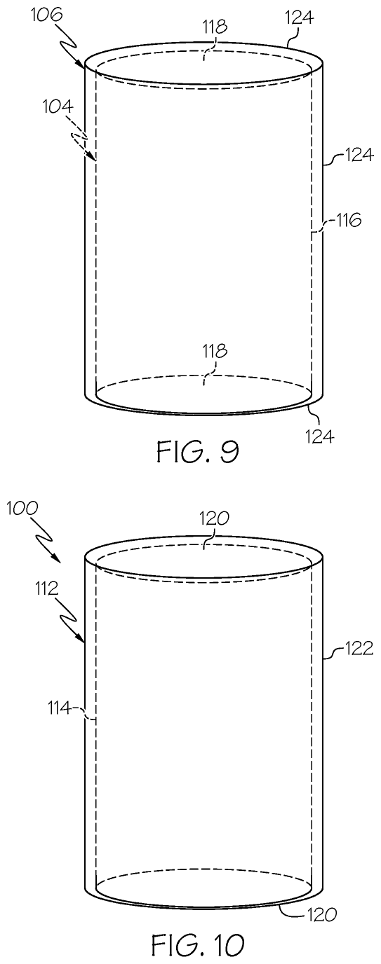

Referring now to FIG. 9, in one or more examples, the composite layup 106 includes at least one composite ply 124 placed on (e.g., over) both of the pair of end bladder-surfaces 118 of the bladder 104. In these examples, the composite layup 106 takes the tubular shape of the peripheral bladder-surface 116 of the bladder 104 and has a closed cross-sectional shape with two closed ends. In FIG. 9, the air fitting 146 is not shown for the purpose of simplicity of illustration.

Referring now to FIG. 10, in one or more examples, the composite layup 106 (e.g., as shown in FIG. 9), placed on the peripheral bladder-surface 116 and both of the end bladder-surfaces 118, is consolidated and cured on the bladder 104, as described herein above, to form the tank-shell 112. In one or more examples, the tank-shell 112 includes the peripheral tank-wall 122 and an opposed pair of end tank-walls 120 that is coupled to the peripheral tank-wall 122. In these examples, peripheral tank-wall 122 takes the tubular shape of the peripheral bladder-surface 116 of the bladder 104 and has a closed cross-sectional shape with two closed ends formed by the end tank-walls 120. The bladder 104 remains within the tank-shell 112 and forms the tank-liner 114. In FIG. 10, the fuel fitting 136 is not shown for the purpose of simplicity of illustration.

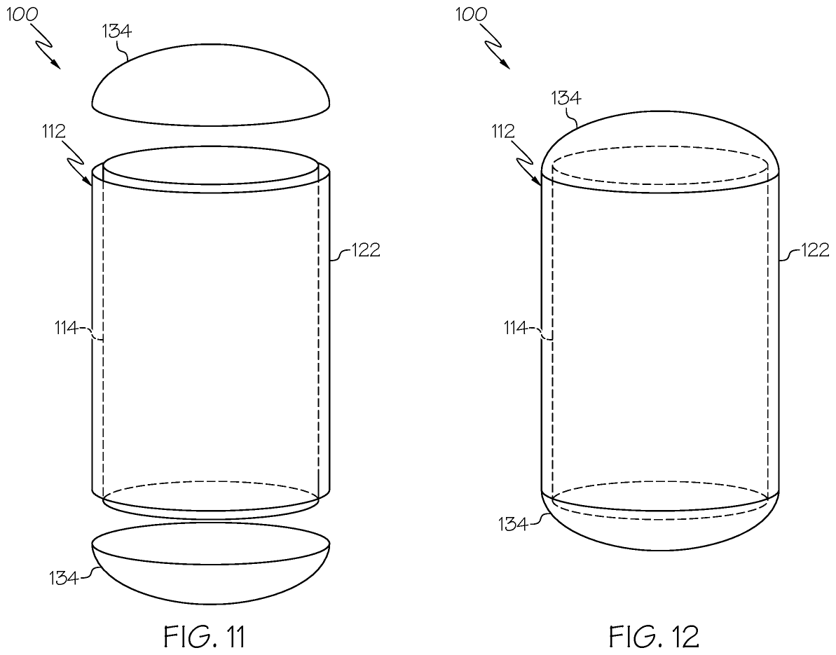

Referring to FIGS. 11 and 12, in one or more examples, the composite fuel tank 102 includes at least one end tank-cover 134, which is coupled to the peripheral tank-wall 122 of the tank-shell 112. The end tank-cover 134 is configured to enclose an open end of the peripheral tank-wall 122 of the tank-shell 112 and cover an exposed portion of the tank-liner 114 after the composite layup 106 is consolidated and cured. In FIGS. 11 and 12, the fuel fitting 136 is not shown for the purpose of simplicity of illustration.

In one or more examples, the composite layup 106 is formed on the peripheral bladder-surface 116 of the bladder 104, as described herein above, such that the tank-shell 112 includes the peripheral tank-wall 122 having the tubular, closed cross-sectional shape with two open ends (e.g., as shown in FIGS. 3 and 4). The bladder 104 remains within the tank-shell 112 and forms the tank-liner 114. As illustrated in FIGS. 11 and 12, in one or more examples, a pair of end tank-covers 134 is coupled to the peripheral tank-wall 122 of the tank-shell 112 at the open ends of the peripheral tank-wall 122. For example, a first one of the pair of end tank-covers 134 is coupled to the peripheral tank-wall 122 of the tank-shell 112 at a first open end of the peripheral tank-wall 122 and a second one of the pair of end tank-covers 134 is coupled to the peripheral tank-wall 122 of the tank-shell 112 at an opposed second open end of the peripheral tank-wall 122.

In one or more examples, the composite layup 106 is formed on the peripheral bladder-surface 116 and one of the end bladder-surfaces 118 of the bladder 104, as described herein above, such that the tank-shell 112 includes the peripheral tank-wall 122 having the tubular, closed cross-sectional shape with an open end and a closed end formed by the end tank-wall 120 (e.g., as shown in FIGS. 7 and 8). The bladder 104 remains within the tank-shell 112 and forms the tank-liner 114. In one or more examples, the end tank-covers 134 are coupled to the peripheral tank-wall 122 of the tank-shell 112 at the open end of the peripheral tank-wall 122, opposite the end tank-wall 120.

The end tank-cover 134 can have any one of various three-dimensional geometries and/or dimensions, depending, for example, on the application of the composite fuel tank 102. Generally, the end tank-cover 134 includes a cross-sectional dimension that matches a cross-sectional dimension of the peripheral tank-wall 122. In one or more examples, an edge portion of the end tank-cover 134 and an end-edge portion of the peripheral tank-wall 122 mate with each other to enable coupling of the end tank-cover 134 to the peripheral tank-wall 122. In one or more examples, the end tank-cover 134 has a contour configured to reduce a drag penalty imposed on a vehicle (e.g., an aircraft) that is carrying the composite fuel tank 102. For example, the end tank-cover 134 has a conical or rounded conical shape, as illustrated in FIGS. 11 and 12. In one or more examples, the end tank-cover 134 is approximately planar (e.g., flat).

The end tank-cover 134 can be made of any one of various types of materials, such as, but not limited to, a composite material (e.g., similar to that of the tank-shell 112), a plastic or polymeric material, or a metallic material. The end tank-cover 134 can be coupled to the tank-shell 112 by any suitable means, such as, but not limited to, adhesive bonding, mechanical fasteners, and the like.

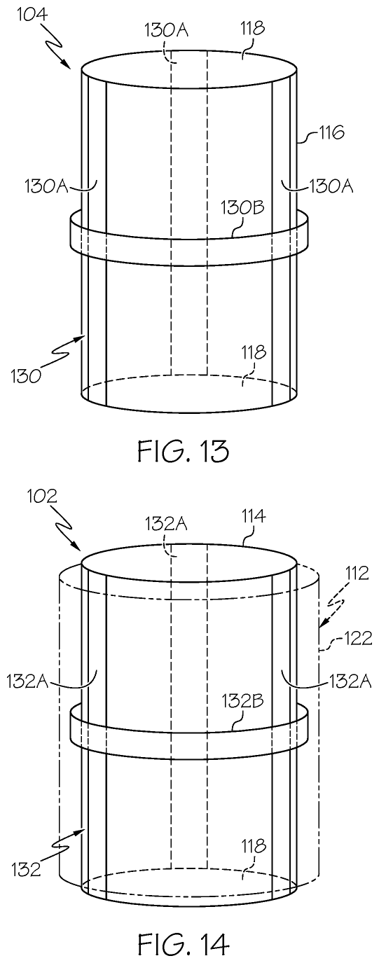

Referring now to FIG. 13, in one or more examples, the system 100 includes a frame member 130. The frame member 130 is located on an exterior surface of the bladder 104. In one or more examples, the system 100 includes any number of frame members 130, such as at least one frame member 130. The frame member 130 is configured to support the bladder 104 during placement of the composite layup 106 on the peripheral bladder-surface 116 and, optionally, on one or both of the end bladder-surfaces 118. In FIG. 13, the air fitting 146 is not shown for the purpose of simplicity of illustration.

As illustrated in FIG. 13, in one or more examples, the one or more frame members 130 includes at least one longitudinal frame member 130A that extends along the peripheral bladder-surface 116, for example, from proximate one (e.g., a first) bladder end-surface 118 to proximate the opposed (e.g., a second) bladder end-surface 118. In one or more examples, the plurality of frame members 130 includes at least one peripheral frame member 130B that extends around an entirety of or a portion of the peripheral bladder-surface 116.

The frame members 130 may be made of any suitable material, such as, but not including, a composite material, a plastic or polymeric material, a metallic material, and the like or combinations thereof.

In one or more examples, the frame members 130 are coupled to the exterior surface of the bladder 104, such as via adhesive bonding. In one or more examples, at least one of the frame members 130 is coupled to at least another one of the frame members 130. For example, the longitudinal frame member 130A are coupled to the peripheral frame member 130B. In one or more examples, each one of the frame members 130 is free from (e.g., not coupled to) another one of the frame members 130.

Generally, the frame members 130 enable further pressurization (e.g., further inflation and expansion) of the bladder 104 during consolidation and cure of the composite layup 106 within the mold 108 (e.g., as shown in FIG. 5). In one or more examples, in which the frame members 130 are coupled to each other, a joint between coupled ones of the frame members 130 is flexible (e.g., expandable) to enable further pressurization of the bladder 104 during consolidation and cure of the composite layup 106.

In one or more examples, the frame members 130 are configured to hold a desired shape of the bladder 104 and/or form more complex geometries for the bladder 104. For example, the frame members 130 may enable the bladder 104 to have one or more contoured portions (e.g., convex or concave surface portions), one or more corners, one or more sloped surface portions, and the like.

In one or more examples, the composite layup 106 includes at least one composite ply 124, which is placed on (e.g., formed over) the frame member 130 while being placed on (e.g., over) the peripheral bladder-surface 116 of the bladder 104. In these examples, the composite layup 106 has the tubular, closed cross-sectional shape formed by the peripheral bladder-surface 116 of the bladder 104 and the frame members 130.

Referring now to FIG. 14, in one or more examples, the composite layup 106, placed on the peripheral bladder-surface 116 and the frame members 130, and, optionally, on one or both of the end bladder-surfaces 118, is placed within the mold 108 and is consolidated and cured on the bladder 104, as described herein above, to form the tank-shell 112. In FIG. 14, the fuel fitting 136 is not shown for the purpose of simplicity of illustration.

In one or more examples, the tank-shell 112 includes the peripheral tank-wall 122 and, optionally, one or both end tank-walls 120 coupled to the peripheral tank-wall 122. In one or more examples, the composite fuel tank 102 includes a tank-frame 132. The tank-frame 132 is coupled to the tank-shell 112. The tank-frame 132 is located between the tank-shell 112 and the tank-liner 114.

In one or more examples, the frame members 130 form the tank-frame 132. For example, the tank-frame 132, formed by the number of frame members 130, is coupled to the tank-shell 112 between the interior surface of tank-shell 112 and the exterior surface of the tank-liner 114. In one or more examples, the frame members 130 are coupled to the interior surface of the tank-shell 112, such as during consolidation and cure of the composite layup 106. The bladder 104 remains within the tank-shell 112, interior of the tank-frame 132, and forms the tank-liner 114.

As illustrated in FIG. 14, in one or more examples, the tank-frame 132 includes at least one longitudinal tank-frame member 132A that extends along an interior surface of the peripheral tank-wall 122, for example, from proximate one (e.g., a first) end of the peripheral tank-wall 122 to proximate the opposed (e.g., a second) end of the peripheral tank-wall 122. In one or more examples, the tank-frame 132 includes at least one peripheral tank-frame member 132B that extends around an entirety of or a portion of the interior surface of the peripheral tank-wall 122.

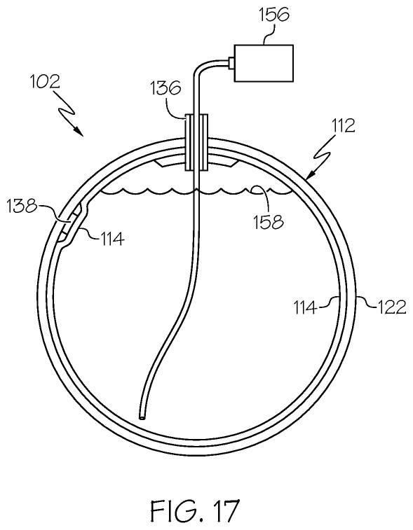

The tank-frame 132 provides an interior support structure for the tank-shell 112 of the composite fuel tank 102. In one or more examples, the tank-frame 132 provides a mounting location and/or structural support for attachment of the end tank-cover 134 (e.g., as shown in FIG. 12) to the tank-shell 112. In one or more examples, the tank-frame 132 provides a mounting location and/or structural support for attachment of one or more pieces of peripheral equipment (e.g., peripheral equipment 138, shown in FIG. 17) to the tank-shell 112. In one or more examples, the tank-frame 132 provides a mounting location and/or structural support for attachment of the composite fuel tank 102 to a vehicle (e.g., an aircraft) or other structure that utilizes the composite fuel tank 102.

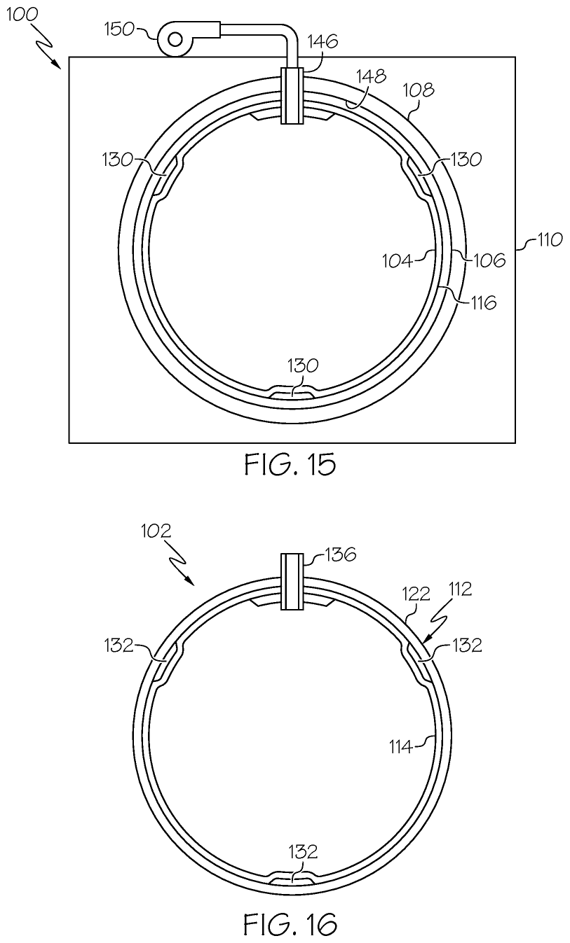

Referring now to FIG. 15, which illustrates an example of the system 100 (e.g., similar to the example of the system 100 shown in FIG. 5) used to consolidate and cure examples of the composite layup 106, placed on the peripheral bladder-surface 116 of the bladder 104 and the frame members 130. After the composite layup 106 is formed on the peripheral bladder-surface 116 of the bladder 104 and the frame members 130, the composite layup 106, the bladder 104, and the frame members 130 are placed within the mold 108. The bladder 104 remains inflated (e.g., initially pressurized) while the composite layup 106, the bladder 104, and the frame members 130 are placed within the mold 108.

With the composite layup 106, the bladder 104, and the frame members 130 positioned within the mold 108, the bladder 104 is further inflated (e.g., further pressurized), for example, via the pump 150, to compress the composite layup 106 against the mold surface 148 of the mold 108, to compress the frame members 130 against the interior surface of the composite layup 106, and to consolidate the composite layup 106. During further pressurization of the bladder 104 and consolidation of the composite layup 106, the peripheral bladder-surface 116 is configured to shape the interior surface of the composite layup 106 and, thus, the interior surface (e.g., the inner mold line) of the peripheral tank-wall 122 of the tank-shell 112, and the mold surface 148 is configured to shape the exterior surface of the composite layup 106 and, thus, the exterior surface (e.g., the outer mold line) of the peripheral tank-wall 122 of the tank-shell 112. The curing apparatus 110 is configured to cure the composite layup 106, positioned on the bladder 104 and the frame members 130, within the mold 108, while the bladder 104 is pressurized to consolidate the composite layup 106 against the mold 108.

Referring now to FIG. 16, which illustrates an example of the composite fuel tank 102 after consolidation and cure of the composite layup 106 (e.g., as shown in FIG. 15). After formation of the composite fuel tank 102, the bladder 104 is depressurized. Thereafter, the bladder 104 forms the tank-liner 114 of the composite fuel tank 102 and the frame members 130 form the tank-frame 132 of the composite fuel tank 102.

Referring now to FIG. 17, which illustrates an example of the composite fuel tank 102, such as in an “in-use” configuration. In one or more examples, the interior volume of the composite fuel tank 102 is at least partially filled with liquid fuel 158. The tank-liner 114 provides a fuel-tight barrier between the liquid fuel 158 and the tank-shell 112. A fuel pump 156 is in fluid communication with the interior volume of the composite fuel tank 102, such as via a fuel line coupled to the fuel fitting 136. While the illustrative example depicts the fuel pump 156 on an exterior of the composite fuel tank 102, in other examples, the fuel pump 156 may be located within the interior volume of the composite fuel tank 102.

In one or more examples, the composite fuel tank 102 includes peripheral equipment 138 (e.g., one or more pieces of peripheral equipment) located within the interior volume of the composite fuel tank 102. In one or more examples, the peripheral equipment 138 is located between the tank-shell 112 and the tank-liner 114. As such, the tank-liner 114 protects the peripheral equipment 138 from the liquid fuel 158. The peripheral equipment 138 includes any device or mechanism associated with use of the composite fuel tank 102. In one or more examples, the peripheral equipment 138 includes a sensor (e.g., a fuel sensor), an electrical component, a computing device, and the like.

In one or more examples, the peripheral equipment 138 is located on an exterior of the bladder 104, such as mounted to the frame member 130, and the composite layup 106 is formed over the peripheral equipment 138. In these examples, the peripheral equipment 138 is equipment capable of withstanding the pressure and/or heat applied during consolidation and cure of the composite layup 106.

In one or more examples, the peripheral equipment 138 is coupled to the interior surface of the tank-shell 112 between the tank-shell 112 and the tank-liner 114, such as to the tank-frame 132, after consolidation and cure of the composite layup 106. In these examples, the peripheral equipment 138 is equipment not capable of withstanding the pressure and/or heat applied during consolidation and cure of the composite layup 106.

It can be appreciated that forming the tank-shell 112 having the peripheral tank-wall 122 with at least one open end (e.g., as shown in FIGS. 4 and 8) may be advantageous for installation of the peripheral equipment 138 within the composite fuel tank 102. For example, the open end of the peripheral tank-wall 122 provides access to the interior surface of the tank-shell 112 and enables the tank-liner 114 to be pulled away from the tank-shell 112 for installation of the peripheral equipment 138.

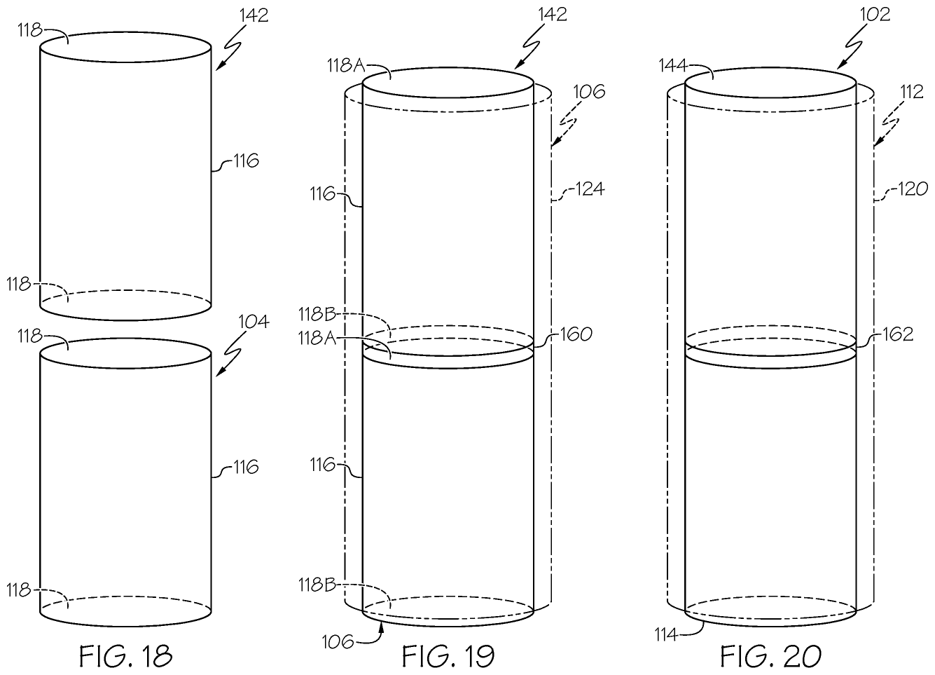

Referring now to FIGS. 18-20, in one or more examples, the system 100 includes a second bladder 142. During fabrication of the composite fuel tank 102, the second bladder 142 is located adjacent (e.g., next) to the bladder 104 (e.g., as shown in FIG. 18). The second bladder 142 is configured to be inflated to support the composite layup 106 (e.g., as shown in FIG. 19), which is formed on at least a portion of the bladder 104 and at least a portion of the second bladder 142. In FIGS. 18 and 19, the air fittings 146 are not shown for the purpose of simplicity of illustration. In FIG. 20, the fuel fittings 136 are not shown for the purpose of simplicity of illustration.

Referring to FIG. 18, the second bladder 142 is substantially the same as the bladder 104, described herein and illustrated in FIG. 2. For example, the second bladder 142 is formed from a sheet of the thermoplastic film 140 (e.g., as shown in FIG. 1). The second bladder 142 is tubular with an opposed pair of closed ends, which form the enclosed internal volume. The second bladder 142 includes the peripheral bladder-surface 116 and the opposed pair of end bladder-surfaces 118. The second bladder 142 includes the air fitting 146.

The second bladder 142 is a dual-purpose component. During fabrication of the tank-shell 112, the second bladder 142 serves as a second inflatable fabrication mandrel for laying up, consolidating, and curing the composite layup 106. The second bladder 142 remains in place during consolidation and cure of the composite layup 106. As such, after formation of the tank-shell 112, the bladder 104 serves as, or forms, the tank-liner 114 and the second bladder 142 serves as, or forms, a second tank-liner 144 of the composite fuel tank 102 (e.g., as shown in FIGS. 20 and 22).

Referring to FIGS. 20 and 22, in one or more examples, the composite fuel tank 102 includes the tank-shell 112, the tank-liner 114 (also referred to as a first tank-liner), and the second tank-liner 144. The tank-liner 114 is located within the tank-shell 112 and forms a first fuel compartment of the composite fuel tank 102. The second tank-liner 144 is located within the tank-shell 112 and forms a second fuel compartment of the composite fuel tank 102.

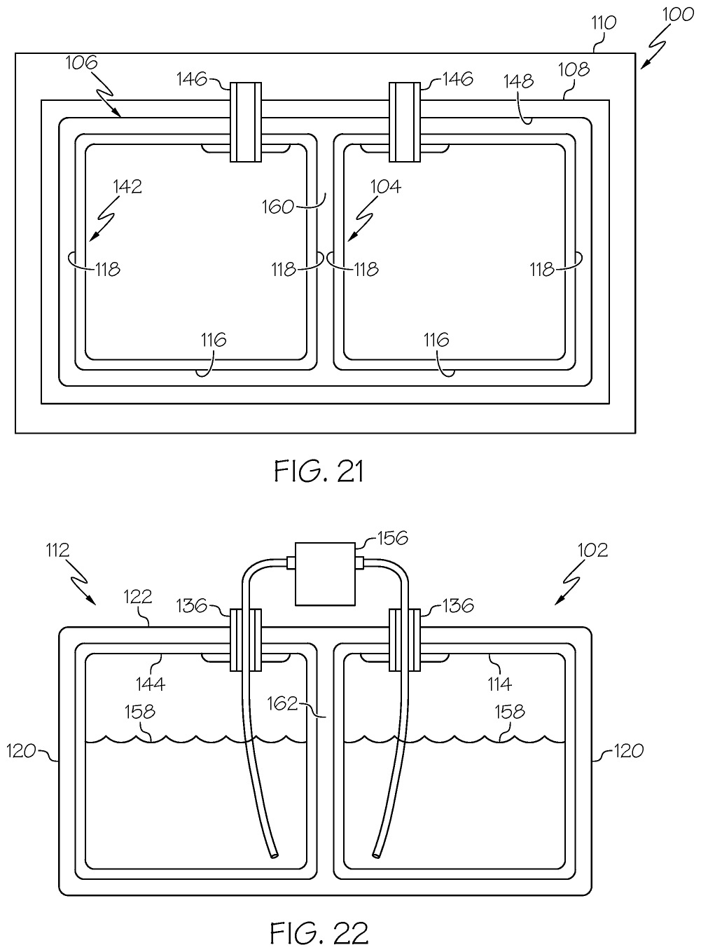

Referring to FIG. 21, in one or more examples, the mold 108 is configured to receive the composite layup 106, the bladder 104, and the second bladder 142. The second bladder 142 is further configured to be pressurized to compress the composite layup 106 against the mold 108. The composite layup 106 is cured within the mold 108 to form the tank-shell 112 (e.g., as shown in FIGS. 20 and 22). The bladder 104 remains in place and is configured to form the tank-liner 114 within the tank-shell 112 and the second bladder 142 remains in place and is configured to form the second tank-liner 144, after formation (e.g., consolidation and cure) of the tank-shell 112.

Referring to FIG. 19, in one or more examples, the composite layup 106 includes at least one ply of composite material (e.g., a composite ply 124) placed on (e.g., around) the peripheral bladder-surface 116 of the bladder 104 and the peripheral bladder-surface 116 of the second bladder 142.

In one or more examples, one or both of the bladder 104 and/or the second bladder 142 may include one or more frame members 130 (e.g., as shown in FIG. 13). In these examples, the composite layup 106 is formed over the frame members 130 associated with the bladder 104 and the second bladder 142, as described herein above.

In one or more examples, the composite layup 106 is formed around substantially an entirety of the peripheral bladder-surface 116 of the bladder 104, for example, from proximate one (e.g., the first) end of the peripheral bladder-surface 116 to proximate the opposing (e.g., the second) end of the peripheral bladder-surface 116. The composite layup 106 is also formed around substantially an entirety of the peripheral bladder-surface 116 of the second bladder 142, for example, from proximate one (e.g., the first) end of the peripheral bladder-surface 116 to proximate the opposing (e.g., the second) end of the peripheral bladder-surface 116. In these examples, the composite layup 106 takes the tubular shape of the peripheral bladder-surface 116 of the bladder 104 and the second bladder 142 and has a closed cross-sectional shape with two open ends.

As illustrated in FIGS. 19 and 21, in one or more examples, a partition 160 is positioned or formed between the bladder 104 and the second bladder 142. The partition 160 may be made of any suitable material, such as, but not limited to, a composite material (e.g., similar to that of the tank-shell 112), a plastic or polymeric material, or a metallic material. In one or more examples, the partition 160 is a solid component. In one or more examples, the partition 160 has one or more openings (e.g., has an annular shape).

Referring to FIGS. 20 and 22, in one or more examples, the composite fuel tank 102 (e.g., the tank-shell 112) includes a partition tank-wall 162. The partition tank-wall 162 is formed from the partition 160 (e.g., as shown in FIGS. 19 and 21) after consolidation and cure of the tank-shell 112. The partition tank-wall 162 extends from the peripheral tank-wall 122 and separates, or defines, the first fuel compartment associated with the tank-liner 114 and the second fuel compartment associated with the second tank-liner 144.

In one or more examples, the composite layup 106 (e.g., at least one ply of composite material) is formed over (e.g., around) the partition 160 while being placed on the peripheral bladder-surface 116 of the bladder 104 and the peripheral bladder-surface 116 of the second bladder 142. In one or more examples, the composite layup 106 (e.g., at least one ply of composite material) is formed over (e.g., around) the partition 160 after a portion of the composite layup 106 has been placed on the peripheral bladder-surface 116 of the bladder 104 and the peripheral bladder-surface 116 of the second bladder 142.

In one or more examples, the composite layup 106 includes at least one composite ply 124, which is placed on (e.g., over) one of the pair of end bladder-surfaces 118 of the bladder 104 (e.g., a first end bladder-surface 118A). The composite layup 106 includes at least one composite ply 124, which is placed on (e.g., over) one of the pair of end bladder-surfaces 118 of the second bladder 142 (e.g., a second end bladder-surface 118B). The portion of the composite layup 106 covering the first end bladder-surface 118A and the second end bladder-surface 118B are placed into contact when the bladder 104 and the second bladder 142 are positioned adjacent to each other and, in combination, form the partition 160. In these examples, the composite layup 106 takes the tubular shape of the peripheral bladder-surfaces 116 of the bladder 104 and the second bladder 142 and has a closed cross-sectional shape with two open ends and the partition 160 located between the bladder 104 and the second bladder 142.

In one or more examples, the composite layup 106, placed on the bladder 104 and the second bladder 142, is consolidated and cured on the bladder 104, as described herein above, to form the tank-shell 112. In one or more examples, the tank-shell 112 includes the peripheral tank-wall 122 and the partition tank-wall 162, which is coupled to the peripheral tank-wall 122. In these examples, peripheral tank-wall 122 takes the tubular shape of the peripheral bladder-surfaces 116 of the bladder 104 and the second bladder 142 and has a closed cross-sectional shape with two open ends. The partition tank-wall 162 is located between the two open ends of the peripheral tank-wall 122. The bladder 104 remains within the tank-shell 112 and forms the tank-liner 114 of the first fuel compartment. The second bladder 142 remains within the tank-shell 112 and forms the second tank-liner 144 of the second fuel compartment.

In one or more examples, the composite layup 106 also includes at least one composite ply 124, which is placed on (e.g., over) the opposing one of the pair of end bladder-surfaces 118 of the bladder 104 (e.g., the second end bladder-surface 118B). The composite layup 106 includes at least one composite ply 124, which is placed on (e.g., over) the opposing one of the pair of end bladder-surfaces 118 of the second bladder 142 (e.g., the first end bladder-surface 118A). In these examples, the composite layup 106 takes the tubular shape of the peripheral bladder-surfaces 116 of the bladder 104 and the second bladder 142 and has a closed cross-sectional shape with two closed ends and the partition 160 located between the bladder 104 and the second bladder 142.

In one or more examples, the composite layup 106, placed on the bladder 104 and the second bladder 142, is consolidated and cured on the bladder 104, as described herein above, to form the tank-shell 112. In one or more examples, the tank-shell 112 includes the peripheral tank-wall 122, the pair of end tank-walls 120, and the partition tank-wall 162, which is coupled to the peripheral tank-wall 122. In these examples, peripheral tank-wall 122 takes the tubular shape of the peripheral bladder-surface 116 of the bladder 104 and has a closed cross-sectional shape with two closed ends formed by the end tank-walls 120. The partition tank-wall 162 is located between the end tank-walls 120. The bladder 104 remains within the tank-shell 112 and forms the tank-liner 114 of the first fuel compartment. The second bladder 142 remains within the tank-shell 112 and forms the second tank-liner 144 of the second fuel compartment.

In one or more examples, the composite fuel tank 102 includes at least one end tank-cover 134, which is coupled to the peripheral tank-wall 122 of the tank-shell 112. The end tank-cover 134 is configured to enclose an open end of the peripheral tank-wall 122 of the tank-shell 112 and cover an exposed portion of the tank-liner 114 and/or the second tank-liner 144 after the composite layup 106 is consolidated and cured.

Referring to FIG. 22, which illustrates an example of the composite fuel tank 102, such as in the “in-use” configuration. In one or more examples, the interior volume of each one of the first and second fuel compartments of the composite fuel tank 102 is at least partially filled with liquid fuel 158. The tank-liner 114 provides a fuel-tight barrier between the liquid fuel 158 and the tank-shell 112 of the first fuel compartment. The second tank-liner 144 provides a fuel-tight barrier between the liquid fuel 158 and the tank-shell 112 of the second fuel compartment. The partition tank-wall 162 separates the tank-liner 114 associated with the first fuel compartment and the second tank-liner 144 associated with the second fuel compartment. The fuel pump 156 is in fluid communication with the interior volume of each one of the first fuel compartment and the second fuel compartment of the composite fuel tank 102, such as via fuel lines coupled to the fuel fittings 136 of each fuel compartment. While the illustrative example depicts the fuel pump 156 on an exterior of the composite fuel tank 102, in other examples, the fuel pump 156 may be located within the interior volume of one of the fuel compartments the composite fuel tank 102. Additionally, while the illustrative example, depicts a single fuel pump 156 operating in parallel with both of the fuel compartments, in other examples, the composite fuel tank 102 may include more than one (e.g., two) fuel pumps 156 operating in series or in independent fluid communication with an associated one of the fuel compartments.

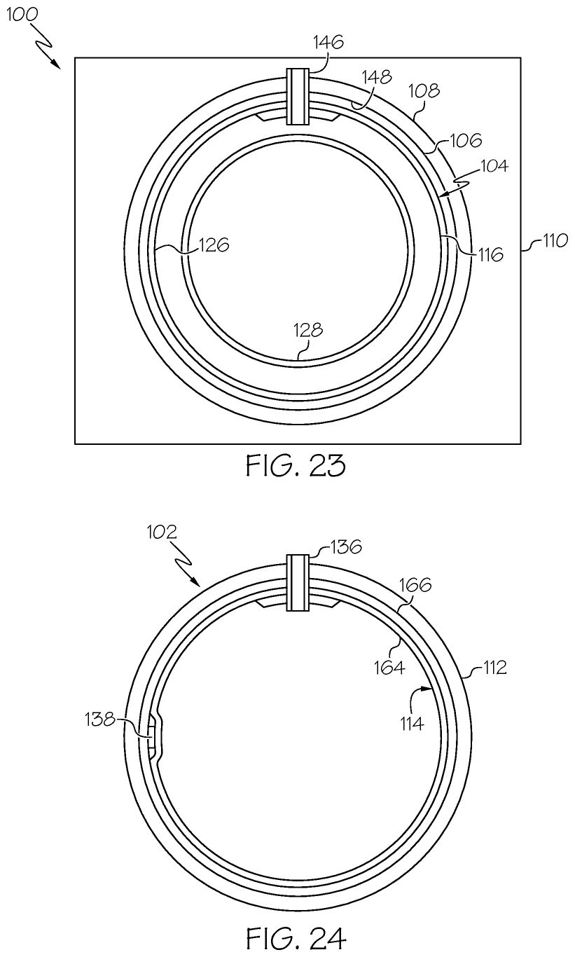

Referring now to FIGS. 23 and 24, in one or more examples, the bladder 104 includes an outer bladder 126 and an inner bladder 128, which is located within the outer bladder 126. The outer bladder 126 is configured to support the composite layup 106 when the bladder 104 is inflated. The outer bladder 126 is configured to compress the composite layup 106 against the mold 108 when the bladder 104 is pressurized. In one or more examples, the inner bladder 128 forms (is configured to form) the tank-liner 114 of the composite fuel tank 102 after fabrication of the tank-shell 112 (e.g., as shown in FIG. 24). In one or more examples, the inner bladder 128 forms (is configured to form) an inner tank-liner 164 and the outer bladder 126 forms (is configured to form) an outer tank-liner 166.

As illustrated in FIG. 24, in one or more examples, the composite fuel tank 102 includes the inner tank-liner 164 and the outer tank-liner 166. The outer tank-liner 166 is positioned between the inner tank-liner 164 and the tank-shell 112. The fuel fitting 136 is coupled to the tank-shell 112, extends through the tank-shell 112, the outer tank-liner 166 and the inner tank-liner 164, and/or is in fluid communication with an interior volume of the inner tank-liner 164 (e.g., of the composite fuel tank 102 interior to the inner tank-liner 164).

In one or more examples, the outer bladder 126 and the inner bladder 128 and, thus, the outer tank-liner 166 and the inner tank-liner 164 are made of the same material, such as the thermoplastic film 140 (e.g., as shown in FIG. 1).

In one or more examples, the outer bladder 126 is configured to be inflated (e.g., initially pressurized), while the inner bladder 128 remains uninflated, to serve as the fabrication mandrel and support placement of the composite layup 106. The outer bladder 126 is also configured to be further pressurized (e.g., further inflated and expanded) to compress the composite layup 106 against the mold surface 148 of the mold 108 (e.g., as shown in FIG. 23) during consolidation and cure of the composite layup 106. In these examples, the air fitting 146 is coupled to the outer bladder 126, extends through outer bladder 126, and/or is in fluid communication with an internal volume of the outer bladder 126.

In one or more examples, the inner bladder 128 is configured to be inflated (e.g., initially pressurized), resulting in inflation of the outer bladder 126, which serves as the fabrication mandrel and support placement of the composite layup 106. The inner bladder 128 is also configured to be further pressurized (e.g., further inflated and expanded), resulting in further pressurization of outer bladder 126, which compresses the composite layup 106 against the mold surface 148 of the mold 108 (e.g., as shown in FIG. 23) during consolidation and cure of the composite layup 106. In these examples, the air fitting 146 is coupled to the outer bladder 126 and the inner bladder 128, extends through outer bladder 126 and the inner bladder 128, and/or is in fluid communication with an internal volume of the inner bladder 128.

It can be appreciated that use of the inner bladder 128 and the outer bladder 126 and, thus, the combination of the inner tank-liner 164 and the outer tank-liner 166 serve as a dual layer fuel liner for the composite fuel tank 102. For examples, the inner tank-liner 164 forms a primary fuel-tight barrier for holding the liquid fuel and the outer tank-liner 166 forms a secondary fuel-tight barrier for holding the liquid fuel.

In can also be appreciated that, in some circumstances, a portion of the thermoplastic material forming the bladder 104 may adhere to the internal surface of the composite layup 106 during consolidation and cure. As such, a portion of the tank-liner 114 may be adhered to the internal surface of the tank-shell 112. Utilization of the outer bladder 126 prevents the inner bladder 128 from contacting and adhering to the internal surface of the composite layup 106 during consolidation and cure and ensures that at least the inner tank-liner 164 is free from the tank-shell 112 after consolidation and cure of the composite layup 106. Preventing the inner tank-liner 164 from adhering to the tank-shell 112 may be advantageous when installing the peripheral equipment 138 (e.g., mounted to the tank-shell 112 between the outer tank-liner 166 and the inner tank-liner 164, as shown in FIG. 24) or otherwise needing access to the interior (e.g., the internal surface) of the tank-shell 112.

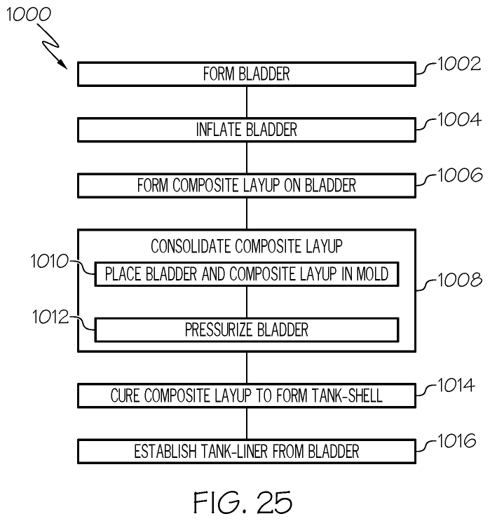

Referring generally to FIGS. 1-24 and particularly to FIG. 25, by way of examples, the present disclosure is also directed to a method 1000 of making the composite fuel tank 102. In one or more examples, implementations of the method 1000 utilize one or more examples of the system 100 to make the composite fuel tank 102.

In one or more examples, the method 1000 includes a step of (block 1002) forming the bladder 104. In one or more examples, the bladder 104 is fabricated and/or formed from a sheet of thermoplastic material, such as the thermoplastic film 140 (e.g., as shown in FIGS. 1 and 2).

In one or more examples, the method 1000 includes a step of (block 1004) inflating the bladder 104. Generally, the step of (block 1004) inflating the bladder 104 includes, or refers to, initial pressurization and inflation of the bladder 104 such that the bladder 104 attains a desired three-dimensional shape to serve as the fabrication mandrel for formation of the composite layup 106 (e.g., as shown in FIGS. 2, 13 and 18).

In one or more examples, the method 1000 includes a step of (block 1006) forming the composite layup 106 on at least a portion of the bladder 104. In one or more examples, the step of (block 1006) forming the composite layup 106 includes placing one or more composite plies on (e.g., around an entirety of or a portion of) the peripheral bladder-surface 116 (e.g., as shown in FIGS. 3, 7, 9, 11 and 19). In one or more examples, the step of (block 1006) forming the composite layup 106 includes placing one or more composite plies on (e.g., over an entirety of or a portion of) one of the end bladder-surfaces 118 (e.g., as shown in FIG. 7). In one or more examples, the step of (block 1006) forming the composite layup 106 includes placing one or more composite plies on (e.g., over an entirety of or a portion of) both end bladder-surfaces 118 (e.g., as shown in FIG. 9).

In one or more examples, the step of (block 1006) forming the composite layup 106 includes placing one or more composite plies on (e.g., over an entirety of or a portion of) the at least one frame member 130.

In one or more examples, the method 1000 includes a step of (block 1008) consolidating the composite layup 106. In one or more examples, the step of (block 1008) consolidating the composite layup 106 includes a step of (block 1010) placing the composite layup 106 and the bladder 104 within the mold 108. The step of (block 1008) consolidating the composite layup 106 includes a step of (1012) pressurizing the bladder 104 to compress the composite layup 106 against the mold 108 and consolidate the composite layup 106. Generally, the step of (block 1012) pressurizing the bladder 104 includes, or refers to, further inflation and expansion of the bladder 104 such that the bladder 104 attains a suitable three-dimensional shape to push that composite layup 106 against the mold surface 148 of the mold 108 (e.g., as shown in FIGS. 5, 15, 21 and 23).

In one or more examples, the method 1000 includes a step of (block 1014) curing the composite layup 106 to form the tank-shell 112 of the composite fuel tank 102 (e.g., as shown in FIGS. 4, 6, 8, 10, 11, 14, 16, 20, 22 and 24). In other words, a composite structure (e.g., the consolidated and cured composite layup 106) serves as, establishes, constitutes, forms, or defines the tank-shell 112 of the composite fuel tank 102.

In one or more examples, the step of (block 1014) curing the composite layup 106 includes a step of applying heat to the composite layup 106. In one or more examples, the step of (block 1014) curing the composite layup 106 includes a step of applying pressure to the composite layup 106. In one or more examples, the step of (block 1014) curing the composite layup 106 includes a step of applying heat and pressure to the composite layup 106.

In one or more examples, the method 1000 includes a step of (block 1016) establishing the tank-liner 114, within the tank-shell 112, from the bladder 104 (e.g., as shown in FIGS. 4, 6, 8, 10, 11, 14, 16, 17, 20, 22 and 24). In other words, the bladder 104 remains in the interior of the composite structure (the tank-shell 112), after consolidating (e.g., block 1008) and curing (e.g., block 1014) the composite layup 106, and serves as, establishes, constitutes, forms, or defines the tank-liner 114 of the composite fuel tank 102.

In one or more examples, the method 1000 includes step of demolding the tank-shell 112 (e.g., removing the tank-shell 112 from the mold 108). In one or more examples, the method includes a step of checking the tank-liner 114 for leaks. In one or more examples, the method 1000 includes a step of removing the air fitting 146. In one or more examples, the method 1000 includes a step of installing the fuel fitting 136 through the tank-shell 112 and the tank-liner 114. In one or more examples, the method 1000 includes installing the peripheral equipment 138 between the tank-shell 112 and the tank-liner 114.

In one or more examples, the method 1000 includes a step of coupling the end tank-cover 134 to the tank-shell 112 (e.g., as shown in FIGS. 11 and 12). In one or more examples, the end tank-cover 134 is coupled to one or both open ends of the peripheral tank-wall 122 of the tank-shell 112.

In one or more examples, according to the method 1000, the bladder 104 includes the outer bladder 126 and the inner bladder 128, which is located within the outer bladder 126. In one or more examples, the step of (block 1004) inflating the bladder 104 includes a step of inflating one of the outer bladder 126 or the inner bladder 128. The step of (block 1012) pressurizing the bladder 104 includes a step of pressuring the one of the outer bladder 126 or the inner bladder 128. The inner bladder 128 forms the tank-liner 114.

In one or more examples, the bladder 104 is supported and/or shaped using the frame members 130 (e.g., as shown in FIG. 13). In one or more examples, according to the method 1000, the step of (block 1006) forming the composite layup 106 on at least a portion of the bladder 104 includes a step of placing one or more composite plies on (e.g., over) the frame members 130 over at least one frame member 130 located on the exterior of the bladder 104. The at least one frame member 130 forms the tank-frame 132, which is coupled to the tank-shell 112 between the tank-shell 112 and the tank-liner 114.

In one or more examples, the method 1000 includes a step of inflating the second bladder 142 located adjacent to the bladder 104 (e.g., as shown in FIG. 18). The method 1000 includes a step of forming the partition 160 between the bladder 104 and the second bladder 142 and forming the composite layup 106 on at least a portion of the first bladder 104 and the second bladder 142. In one or more examples, the step of (block 1008) consolidating the composite layup 106 includes a step of placing the composite layup 106, the bladder 104, and the second bladder 142 within the mold 108 and a step of pressurizing the bladder 104 and the second bladder 142 to compress the composite layup 106 against the mold 108. The method 1000 includes a step of forming the second tank-liner 144 within the tank-shell 112 from the second bladder 142.

Examples of the composite fuel tank 102, made using the system 100 and/or according to the method 1000, may be used in any one of various applications. As an example, the composite fuel tank 102 may serve as an external fuel tank for a terrestrial, aerial, or marine vehicle that use liquid fuel. As another example, the composite fuel tank 102 may serve as a fuel tank for a weapon (e.g., rocket or missile) that uses liquid fuel. As another example, the composite fuel tank 102 may serve as a fuel tank (e.g., internal or external) for an attritable ground or air vehicle, such as an unmanned aerial vehicle (UAV), unmanned aircraft system (UAS), unmanned ground vehicle (UGV), and the like. As used herein, the term “attritable” refers to an item being low-cost, being single use or reusable and eventually expendable, and having minimal maintenance requirements.

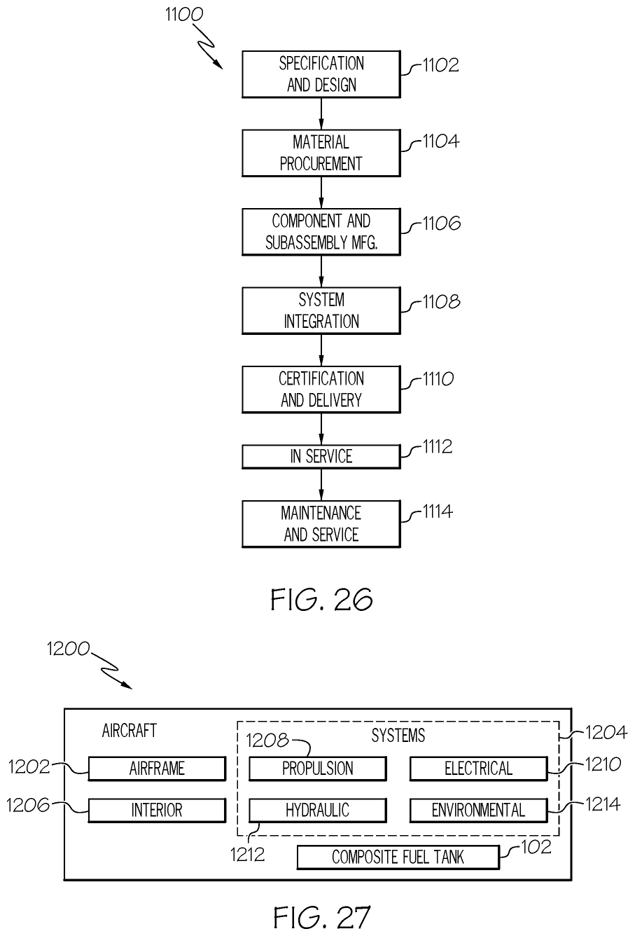

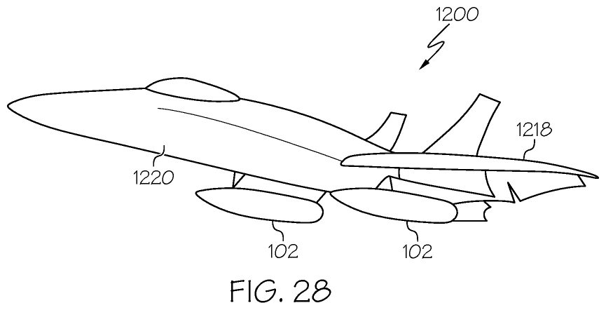

Referring now to FIGS. 26-28, examples of the composite fuel tank 102, the system 100 and the method 1000 may be related to, or used in the context of, an aircraft manufacturing and service method 1100, as shown in the flow diagram of FIG. 26 and the aircraft 1200, as schematically illustrated in FIGS. 27 and 28. For example, the aircraft 1200 may include the composite fuel tank 102 and/or the aircraft production and service methodology 1100 may utilize the system 100 to make the composite fuel tank 102 according to the method 1000 described herein.

Referring to FIGS. 27 and 28, examples of the aircraft 1200 may include an airframe 1202 having the interior 1206. The aircraft 1200 also includes a plurality of high-level systems 1204. Examples of the high-level systems 1204 include one or more of a propulsion system 1208, an electrical system 1210, a hydraulic system 1212, and an environmental system 1214. In other examples, the aircraft 1200 may include any number of other types of systems, such as a flight control system, a communications system, a guidance system, a weapons system, and the like. In one or more examples, the composite fuel tank 102, made using the system 100 and/or according to the method 1000, is used as a fuel tank, such as an exterior or supplementary fuel tank, of the aircraft 1200 (e.g., as shown in FIG. 28). For example, one or more composite fuel tanks 102 may be mounted to an exterior of the aircraft 1200, such as to the wings 1218 or the fuselage 1220 of the aircraft 1200.

Referring to FIG. 26, during pre-production, the method 1100 includes specification and design of the aircraft 1200 (block 1102) and material procurement (block 1104). During production of the aircraft 1200, component and subassembly manufacturing (block 1106) and system integration (block 1108) of the aircraft 1200 take place. Thereafter, the aircraft 1200 goes through certification and delivery (block 1110) to be placed in service (block 1112). Routine maintenance and service (block 1114) includes modification, reconfiguration, refurbishment, etc. of one or more systems of the aircraft 1200.

Each of the processes of the method 1100 illustrated in FIG. 26 may be performed or carried out by a system integrator, a third party, and/or an operator (e.g., a customer). For the purposes of this description, a system integrator may include, without limitation, any number of spacecraft manufacturers and major-system subcontractors; a third party may include, without limitation, any number of vendors, subcontractors, and suppliers; and an operator may be an airline, leasing company, military entity, service organization, and so on.

Examples of the composite fuel tank 102, the system 100 and/or the method 1000, shown and described herein may be employed during any one or more of the stages of the manufacturing and service method 1100 shown in the flow diagram illustrated by FIG. 26. In an example, fabrication of the composite fuel tank 102, in accordance with the method 1000 and/or using the system 100, may form a portion of component and subassembly manufacturing (block 1106) and/or system integration (block 1108). Further, the composite fuel tank 102, made in accordance with the method 1000 and/or using the system 100, may be utilized in a manner similar to components or subassemblies prepared while the aircraft 1200 is in service (block 1112). Also, the composite fuel tank 102, made in accordance with the method 1000 and/or using the system 100, may be utilized during system integration (block 1108) and certification and delivery (block 1110). Similarly, the composite fuel tank 102, made in accordance with the method 1000 and/or using the system 100, may be utilized, for example and without limitation, while the aircraft 1200 is in service (block 1112) and during maintenance and service (block 1114). Further, examples of the composite fuel tank 102 may be designed to be releasable, reusable, attritable, and/or expendable from the aircraft 1200 either during component and subassembly manufacturing (block 1106), system integration (block 1108), certification and delivery (block 1110), while the aircraft is in service (block 1112), and/or during maintenance and service (block 1114).

Although an aerospace example is shown, the examples and principles disclosed herein may be applied to other industries, such as the automotive industry, the space industry, the construction industry, and other design and manufacturing industries. Accordingly, in addition to aircraft, the examples and principles disclosed herein may apply to composite fuel tanks having integral liners and systems and methods of making the same for other types of vehicles (e.g., land vehicles, marine vehicles, space vehicles, etc.) and stand-alone structures.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component or step preceded with the word “a” or “an” should be understood as not excluding a plurality of features, elements, components or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “a number of” refers to one or more items.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represent a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1-24, 27 and 28, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1-24, 27 and 28, referred to above, need be included in every example and not all elements, features, and/or components described herein are necessarily depicted in each illustrative example. Accordingly, some of the elements, features, and/or components described and illustrated in FIGS. 1-24, 27 and 28 may be combined in various ways without the need to include other features described and illustrated in FIGS. 1-24, 27 and 28, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1-24, 27 and 28, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1-24, 27 and 28, and such elements, features, and/or components may not be discussed in detail herein with reference to each of FIGS. 1-24, 27 and 28. Similarly, all elements, features, and/or components may not be labeled in each of FIGS. 1-24, 27 and 28, but reference numerals associated therewith may be utilized herein for consistency.

In FIGS. 25 and 26, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 25 and 26 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but do not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the composite fuel tank 102, the system 100 and the method 1000 have been shown and described, modifications may occur to those skilled in the art upon reading the specification. The present application includes such modifications and is limited only by the scope of the claims.

What is claimed is:

1. A system for making a composite fuel tank, the system comprising:
a bladder configured to be inflated to support a composite layup formed on at least a portion of the bladder;
a mold configured to receive the composite layup and the bladder, wherein:
the bladder is further configured to be pressurized to compress the composite layup against the mold;
the composite layup is cured within the mold to form a tank-shell; and
the bladder is configured to form a tank-liner within the tank-shell.

2. The system of claim 1, wherein the bladder is made of a thermoplastic material.

3. The system of claim 1, wherein:
the bladder comprises a peripheral bladder-surface and an opposed pair of end bladder-surfaces;
the composite layup comprises at least one composite ply placed around the peripheral bladder-surface of the bladder; and
the tank-shell comprises a peripheral tank-wall.

4. The system of claim 3, wherein:
the composite layup further comprises at least one composite ply placed over at least one of the pair of end bladder-surfaces of the bladder; and
the tank-shell further comprises an end tank-wall coupled to the peripheral tank-wall.

5. The system of claim 3, wherein:
the composite layup further comprises at least one composite ply placed over the pair of end bladder-surfaces of the bladder; and
the tank-shell further comprises an opposed pair of end tank-walls coupled to the peripheral tank-wall.

6. The system of claim 1, wherein:
the bladder comprises:
an outer bladder; and
an inner bladder located within the outer bladder;
the outer bladder is configured to support the composite layup when the bladder is inflated;
the outer bladder is configured to compress the composite layup against the mold when the bladder is pressurized; and
the inner bladder forms the tank-liner.

7. The system of claim 1, further comprising:
at least one frame member located on an exterior of the bladder, wherein:
the composite layup is formed over the at least one frame member; and
the at least one frame member forms a tank-frame that is coupled to the tank-shell between the tank-shell and the tank-liner.

8. A method of making a composite fuel tank, the method comprising steps of:
inflating a bladder;
forming a composite layup on at least a portion of the bladder;
pressurizing the bladder to compress the composite layup against a mold;
curing the composite layup to form a tank-shell; and
establishing a tank-liner within the tank-shell from the bladder.

9. The method of claim 8, wherein:
the bladder comprises a peripheral bladder-surface and an opposed pair of end bladder-surfaces;
the step of forming the composite layup comprises placing at least one composite ply around the peripheral bladder-surface of the bladder; and
the tank-shell comprises a peripheral tank-wall.

10. The method of claim 9, wherein:
the step of forming the composite layup further comprises placing at least one composite ply over at least one of the pair of end bladder-surfaces of the bladder; and
the tank-shell further comprises an end tank-wall coupled to the peripheral tank-wall.

11. The method of claim 9, wherein:
the step of forming the composite layup further comprises placing at least one composite ply over the pair of end bladder-surfaces of the bladder; and
the tank-shell further comprises an opposed pair of end tank-walls coupled to the peripheral tank-wall.

12. The method of claim 9, further comprising coupling at least one end tank-cover to the peripheral tank-wall of the tank-shell.

13. The method of claim 8, wherein:
the bladder comprises:
an outer bladder; and
an inner bladder located within the outer bladder;
the step of inflating the bladder comprises inflating one of the outer bladder or the inner bladder;
the step of pressurizing the bladder comprises pressuring the one of the outer bladder or the inner bladder; and
the inner bladder forms the tank-liner.

14. The method of claim 8, further comprising installing a fuel fitting through the tank-shell and the tank-liner.

15. The method of claim 8, further comprising installing peripheral equipment between the tank-shell and the tank-liner.

16. The method of claim 8, wherein:
the step of forming the composite layup on at least a portion of the bladder comprises forming the composite layup over at least one frame member located on an exterior of the bladder; and
the at least one frame member forms a tank-frame that is coupled to the tank-shell between the tank-shell and the tank-liner.

17. The method of claim 8, further comprising forming the bladder from a thermoplastic film.

18. The method of claim 8, further comprising:
inflating a second bladder located adjacent to the bladder;
forming the composite layup between the bladder and the second bladder and on at least a portion of the second bladder;
pressurizing the second bladder to compress the composite layup against the mold; and
forming a second tank-liner within the tank-shell from the second bladder.

19. A composite fuel tank comprising:
a tank-shell; and
a tank-liner located within the tank-shell,
wherein:
the tank-shell is formed from a composite layup that is placed, consolidated, and cured on a bladder; and
the bladder forms the tank-liner after formation of the tank-shell.

20. The composite fuel tank of claim 19, further comprising a tank-frame coupled to the tank-shell between the tank-shell and the tank-liner.
